(19) United States
(12) Patent Application Publication
(10) Pub. No.: US 2004/0163091 A1
(43) Pub. Date: Aug. 19, 2004

(54) Attributes bridging solution and method of using the same

(76) Inventor: Gregory M. Brill, Upper Saddle River, NJ (US)

Correspondence Address: Tony D. Alexander, TECHNOLOGY LEGAL COUNSEL LLC, POST OFFICE BOX 1728, EVANS, GA, 30809, US

(21) Appl. No.: 10/370,185

(22) Filed: Feb. 19, 2003

(51) Int. Cl. G06F 9/00

(52) U.S. Cl. 719/328

(57) ABSTRACT

The .NET attributes bridge in accordance with the present invention provides a simple way to develop distributed middleware applications for the .NET platform with little or no programming. .NET provides a mechanism to extend the meaning of code with metadata with the use of attributes. The present method, system and program provide a set of attributes, which can be used to declaratively specify what features of the middleware API to enable. These features include, but are not limited to, sending and receiving reliable or certified messages, enabling fault tolerant operation, or leveraging distributed queues. As a result, a programmer can leverage the functionality of products of multiple vendors' middleware without having to learn the respective APIs.

### COPYRIGHT NOTICE

A portion of the disclosure of this patent document contains material that is subject to copyright protection. The copyright owner has no objection to the facsimile reproduction by anyone of the patent disclosures, as it appears in the Patent and Trademark Office patent files or records, but otherwise reserves all copyright rights whatsoever.

### FIELD OF THE INVENTION

This present invention pertains generally to software programming tools, and more particularly, methods, systems and program products that allow programmers to integrate middleware products without having to learn various Application Programming Interfaces.

### BACKGROUND OF THE INVENTION

As the desire to transact business via computer networks increased, a need developed for an open standard to remove barriers to data sharing and software integration. Moreover, there was a need for a system that allowed developers access to software that was not operating system specific in general or reliant on operating system specific application programming interfaces (APIs) in particular.

The first part of the solution was provided by Microsoft® .NET, which is a set of software technologies for connecting information, people, systems, and devices. It enables a high level of software integration through the use of XML Web services—small, discrete, building-block applications that connect to each other as well as to other, larger applications over the Internet. .NET is integrated into the products that make up the Microsoft platform, providing the ability to quickly and reliably build, host, deploy, and utilize connected solutions using XML Web services, all with the protection of industry-standard security technologies. Moreover, vendors even provided middleware solutions that allowed developers to write their code once and deploy it to any operating system, which uses the same middleware.

However, middleware has its own application programming interfaces (APIs) to help insulate software developers from operating system-specific APIs. Unfortunately, by providing their own APIs, middleware still creates a burden for programmers attempting to integrate their own products with multiple middleware products. In order to integrate products from multiple vendors, the programmer has to learn the APIs of a plurality of vendors.

Therefore, there remains a need for a program, system or method that would allow a programmer to integrate multiple middleware products into his or her own software without having to learn multiple APIs to communicate with the middleware. In particular, there is a need for a layer of abstraction between the programmer and the middleware API. There is also a need for a program system or method that allows the programmer to make middleware an implicit part of .NET development by using .NET constructs to communicate with middleware.

### SUMMARY OF EXEMPLARY EMBODIMENTS

Solutions to the problems outlined above are proposed using a program, system and method of creating a layer of abstraction between the programmer and the middleware API. In particular, the present inventor has designed a novel method that allows programmers to make middleware an implicit part of .NET development, by using .NET constructs, such as attributes, to communicate with middleware. An advantage of an exemplary program, system and method of the present invention is that the programmer does not have to learn specific APIs to communicate with the middleware.

It is a principal objective in accordance with a preferred embodiment of the present invention to provide a parsimonious approach to programming with the .NET platform. In the .NET software development environment, programmers usually interface with middleware through Application Programming Interfaces. These APIs are function calls that demand the programmer learns a specific series of functions that make up the middleware API. However, the present invention, in a preferred embodiment, provides a program, system and method for programming on the .NET platform without having to learn the vendor specific APIs. In the furtherance of this and other objectives, the present invention takes advantage of what are know as .NET attributes to eliminate the need to learn multiple middleware APIs.

Still another objective in accordance with a preferred embodiment of the present invention is to provide a means for making middleware an implicit part of .NET development, by using .NET constructs to communicate with middleware.

Yet another objective of the present invention is to provide programs, systems and methods that allows programmers to deploy middleware in general and TIBCO & IBM products in particular, ubiquitously through the .NET environment.

The number and variability of applications, programs, systems and methods, in accordance with the present invention, are limited only by the imagination of the user.

Further objectives, features and advantages of the invention will be apparent from the following detailed description taken in conjunction with the accompanying drawings.

### BRIEF DESCRIPTION OF THE DRAWINGS OF PREFFERED EMBODIMENTS

FIG. 1 is pseudo code corresponding to a Calling the standard TIBCO Rendezvous API from .NET;

FIG. 2 is pseudo code corresponding to a TIBCO communication using the attribute bridging method of a preferred embodiment of the present invention;

FIG. 3 is pseudo code corresponding to Rendezvous messaging implementation steps using standard API constructs;

FIG. 4 is pseudo code corresponding to Rendezvous messaging implementation step using the attribute bridging method of a preferred embodiment of the present invention;

FIG. 5 is pseudo code corresponding to an alternative message receiving implementation step using the attribute bridging method of a preferred embodiment of the present invention; and

FIG. 6 is a schematic diagram of the architecture of an exemplary bridging solution in accordance with the present invention.

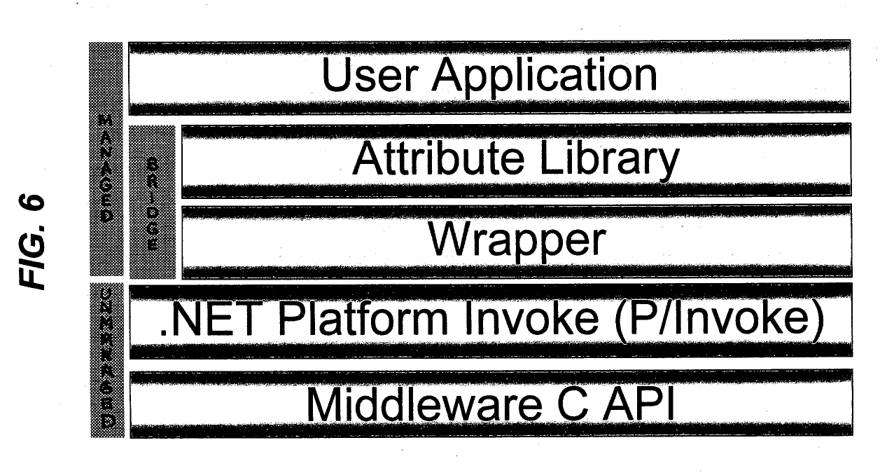

### DETAILED DESCRIPTION OF PREFERRED EMBODIMENTS

The .NET attributes bridging solution in accordance with the present invention provides a simple way to develop distributed middleware applications for the .NET platform with little or no programming. .NET provides a mechanism to extend the meaning of code with metadata with the use of attributes. The present method, system and program, provide a set of attributes, which can be used to declaratively specify what features of the middleware API to enable. These features include, but are not limited to, sending and receiving reliable or certified messages, enabling fault tolerant operation, or leveraging distributed queues. As a result, a programmer can leverage the functionality of products of multiple vendors' middleware without having to learn the respective APIs. By way of illustration, below is a brief description of how a middleware bridging solution in accordance with the present invention can be applied to messaging middleware in general and TIBCO Rendezvous™ in particular.

1.0 Introduction

With respect to specific messaging applications, an embodiment of the bridging solution in accordance with the present invention allows developers to seamlessly leverage the complete messaging infrastructure of, for example, TIBCO Rendezvous™ from any programming language supported by the .NET platform (e.g., NetCOBOL, Visual J#.NET, Managed C++, C#, Visual Basic .NET, etc.). A further advantage is little or no middleware training is required to leverage all major TIBCO Rendezvous™ features from the .NET bridging solution, including fault tolerance, distributed queues, certified messaging, and other key features. A preferred middleware bridging solution, in accordance with the present invention, combines all the advantages of TIBCO's high-volume Enterprise Application Integration (EAI) middleware and .NET's superior development environment and support for all major languages. The result is a simple to learn but extremely powerful gateway between .NET and EAI.

The messaging bridge solution has two components, namely, the wrapper and the library. The wrapper is a direct port of the Rendezvous C API to .NET. .NET provides an efficient interoperability facility called Platform Invoke (P/Invoke), which allows .NET-based applications to interact with legacy code, such as the Rendezvous C Library. The wrapper allows .NET applications to exploit all key features of the TIBCO Rendezvous™ messaging system through the power, flexibility and complete control offered by the low-level C API. Developers already familiar with the Rendezvous APIs will effortlessly be able to leverage them from any .NET language without needing any retraining.

One of the more innovative productivity-enhancing features of the .NET platform is the ability to use attributes. Developers can annotate their code with simple keyword-like descriptions, called attributes, to automatically take advantage of runtime services without having to explicitly code for them. The Attribute Library allows developers to use the TIBCO Rendezvous™ messaging infrastructure through this high-level, declarative programming style and does not impose a requirement to know TIBCO Rendezvous™-specific API calls. .NET programmers can send or receive reliable or certified messages by using the programmatic constructs they are familiar with such as methods and events. Throughout this discussion reference will be made to pseudo code, which will for short be referred to as PC. PC and pseudo code may be used interchangeably throughout this specification.

PSEUDO CODE 1.1:
Sending a reliable message using the Attribute Library

```
using System;
using Infusion.Tibrv.Attributes;
using Infusion.Tibrv.Attributes.Messaging;
[ReliableTransport]
public interface IPublisher
{
  [subject(“sample.app”)]
  void Publish(string symbol, double quote);
}
class StockApp
{
  static void Main( )
  {
    IPublisher pub =
    (IPublisher)MessagingServices.CreateProxy(typeof(IPublisher));
    pub.Publish(“ABCD”, 14.23);
  }
}
```

The use of attributes allows any .NET programmer with no Rendezvous experience to leverage the strengths of Rendezvous without requiring an understanding of the Rendezvous API. PC 1.1 demonstrates how a developer can simply invoke a method to send a message oh the TIB.

The transmitted message is fully compliant with the self-describing, platform-neutral format of all Rendezvous messages, and as such, any Rendezvous-compliant listener on the TIB is capable of consuming messages produced by publishers using the Attribute Library. Conversely, the Attribute Library can be used in a similar fashion to subscribe to messages on the TIB:

PSEUDO CODE 1.2:
Receiving a reliable message using the Attribute Library

```
using System;
using Infusion.Tibrv.Attributes;
using Infusion.Tibrv.Attributes.Messaging;
[ReliableTransport]
public class StockSubscriber
{
  static void Main( )
  {
    StockSubscriber sub = new StockSubscriber( );
    MessagingServices.RegisterObject(sub);
    Console.ReadLine( ); // wait for messages
  }
  [Subject(“sample.app”)]
  public void ReceiveQuote(string symbol, double quote)
  {
    // This method is called when a message arrives
    Console.WriteLine(“Symbol = {0}, quote = {1}”, symbol, quote);
  }
}
```

An important consequence of the Attribute Library's ability to support fully-compliant TIBCO Rendezvous™ messages is that any application within the TIBCO ActiveEnterprise™ suite can integrate with applications using the Attribute Library, such as the TIBCO Hawk monitoring and management system or the TIBCO MessageBroker™ message transformation engine. All other Rendezvous features are likewise available to the .NET developer as simple to use attributes.

Below, PC 1.3 demonstrates how to send a certified message using the Attribute Library.

PSEUDO CODE 1.3:
Sending a certified message using the Attribute Library

```
using System;
using Infusion.Tibrv.Attributes;
using Infusion.Tibrv.Attributes.Messaging;
[ReliableTransport]
[CertifiedTransport(“CertSender”)]
[Subject(“sample.app”)]
public delegate void StockUpdate(string symbol, double quote);
class StockAlert
{
  static void Main( )
  {
    StockUpdate stk =
      (StockUpdate)MessagingServices.CreateProxy(typeof(StockUpdate));
    stk(“ABCD”, 12.34);
  }
}
```

In addition to supporting basic sending and receiving functionality via simple attributes, the Attribute Library exposes the full functionality of fault-tolerance and distributed queues demanded by mission-critical server environments. For example, to specify that a .NET class is a member of a fault tolerant group, all that is required is a single attribute:

PSEUDO CODE 1.4:
Designating a class as a member of a fault tolerant group

```
using System;
using Infusion.Tibrv.Attributes;
using Infusion.Tibrv.Attributes.Messaging;
[ReliableTransport]
[FaultTolerantMember(“ftGroup”)]
public class StockAlert : IFtMember
{
  public void Notify(string groupName, FtMemberAction action)
  {
    // Changes within the FT group are
    // communicated through this method
  }
}
```

As stated above, a preferred embodiment of the bridging solution of the present invention is comprised of two components. The first is a highly efficient Middleware Wrapper providing fine-grained control over the middleware API. The second is an Attribute Library that makes the middleware an integrated part of .NET. In this way, .NET developers can leverage all the features of the middleware without any understanding of or training in the middleware: simply understanding basic concepts in .NET is sufficient. Through a series of profoundly simple to learn .NET attributes, any middleware feature involving reliable or certified messaging, fault tolerance, distributed queues and other features can be leveraged. In short, the present middleware bridging solution is a simple and robust way to combine the powerful features of both .NET and high-volume middleware.

Applications for the invention also include other applications that as of now are unidentified. However, it should be understood that attributes are used in .NET as “metadata” tags that are placed on top of functions, variables, or entire compiled libraries. These tags are interpreted by the .NET runtime and they indicate special handling of the element to which they are attached. For example, to make a function callable only by a “manager”, you might have something like:

[IsInRole(“managers”)]

void SomeFunction(void)

Here “IsInRole” is one of many attributes contained within the .NET libraries. Security is only one place where attributes are used: they are also used to indicate performance preferences, transactional needs, to indicate that portions of a program are web accessible, to call “native” low level libraries of an operating system, etc. As a result, after exposure to the present invention, one of ordinary skill in the art could conceive a wide variety of applications for the present bridging solution that do not depart from the spirit of the invention.

2.0 Definitnions

The following terms are used throughout this specification and should be construed in accordance with the following definitions and not inconsistent with their usage herein:

Application Programming Interface (API): An interface between the operation system and application programs, which includes the way the application programs communicate with the operating system, and the services the operating system makes available to the programs. Moreover, an API is a definition of how a computer programming language can interact with other software. All leading databases provide API's that allow programmers to write code to directly control the database system.

Attribute: The portion of the declarative information unit of deployment that describes identity (name, version and culture), additional product or company information, configuration information and security & authentication information.

Middleware: Any of a wide variety of server applications between end-users and primary services in an n-tier system. Generally used to increase the number of users that can access the primary services.

N-tier system: A system of computers with at least 3 logical tiers, or layers: a front-end layer for users, usually web browsers or specific-purpose applications with Graphical User Interfaces (presentation layer); a middleware layer for business logic and scalability, such as web servers and fast-cache servers (application layer); and a back-, end for primary services and storage, such as databases and email servers (data services layer). More than 3 layers would be additional middleware or back-end layers.

### 3.0 GENERAL DESCRIPTION OF A PREFERRED Embodiment

The present invention may be embodied in several forms, but in a preferred embodiment, a novel program, system and method is provided that allows programmers to make middleware an implicit part of .NET development, by using .NET constructs such as attributes to communicate with middleware.

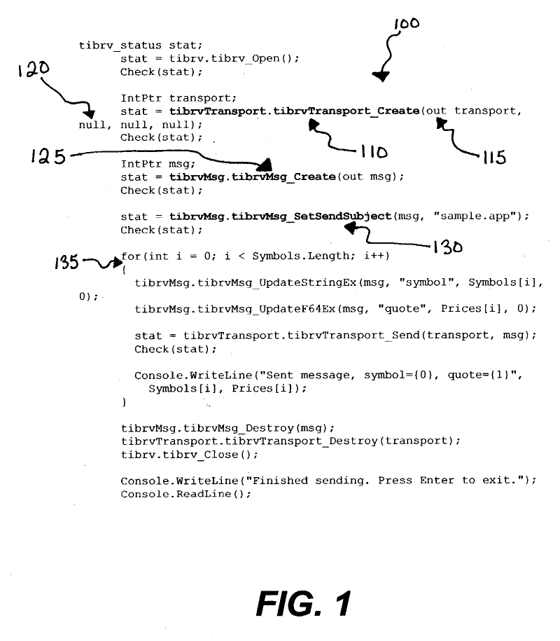

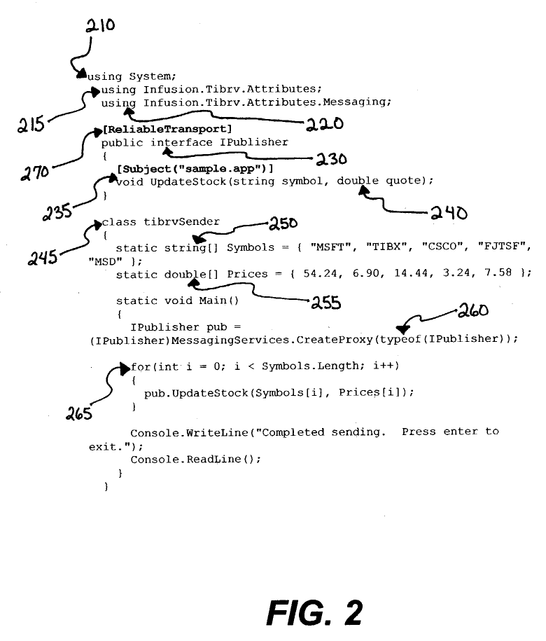

In order to communicate, for example, with TIBCO or IBM MQ Series middleware on the .NET platform, use of the vendor's API is necessary. Code for facilitating such communication would look something like that shown in FIG. 1 (In the present FIGS, pseudo code is provided for TIBCO or IBM MQ Series middleware, for example purposes only, and should in no way be construed as limiting the invention to the integration of these middleware products). Referring specifically to the pseudo code of FIG. 1, the calling API routines are indicated in bold. FIG. 1 illustrates, through pseudo code, a programmer calling the standard TIBCO Rendezvous™ API from .NET. However, using .NET Attributes, communicating with TIBCO, MQ Series, etc can be done in an alternative way. Referring now to FIG. 2, it becomes apparent that a programmer can use .NET Attributes to integrate with TIBCO Rendezvous (RV) from Microsoft .NET. In these examples, you will note that no API specific code was necessary and that the .NET attributes indicated that the code was to communicate with TIBCO.

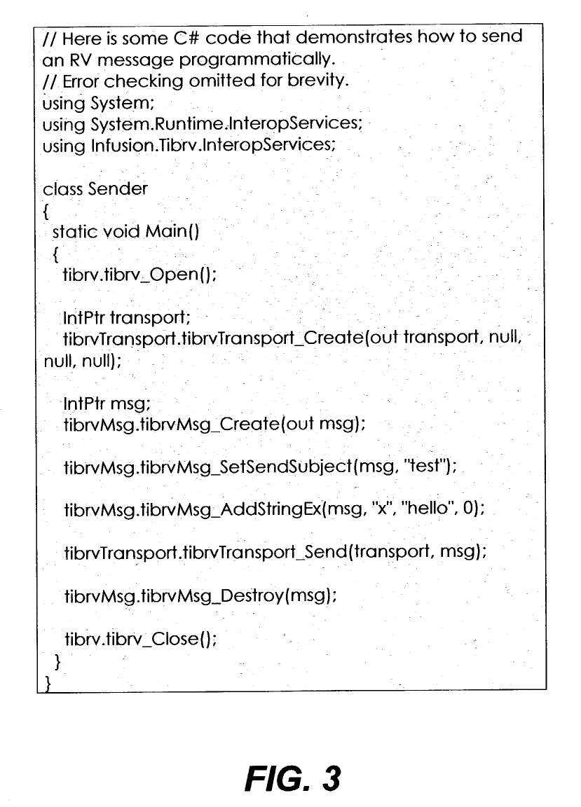

In FIGS. 1-5 you see two methods of integrating, for example, TIBCO® messaging middleware. The first method (as shown in FIGS. 1 and 3) uses a standard API approach to leveraging the middleware. In the bolded and numbered items of FIG. 1, at step 100 we are calling a standard middleware API to open a session to communicate with the middleware engine. Step 110 involves calling an API (tibrvTransport_Create) to create a message transport on which messages will be sent. Steps 115 through 120 are arguments that must be passed to the library method. Step 125 involves the creation of a message object to hold the message. Step 130 involves setting the subject of that message (the subject indicates what the message is “about” and listeners who are interested in that subject will want to examine the message. In step 135, other APIs are called to set the “symbol” and “quote” fields with values and we are then sending a message on the transport so that interested parties elsewhere on the network can receive and decipher the message. Note that standard APIs are being used.

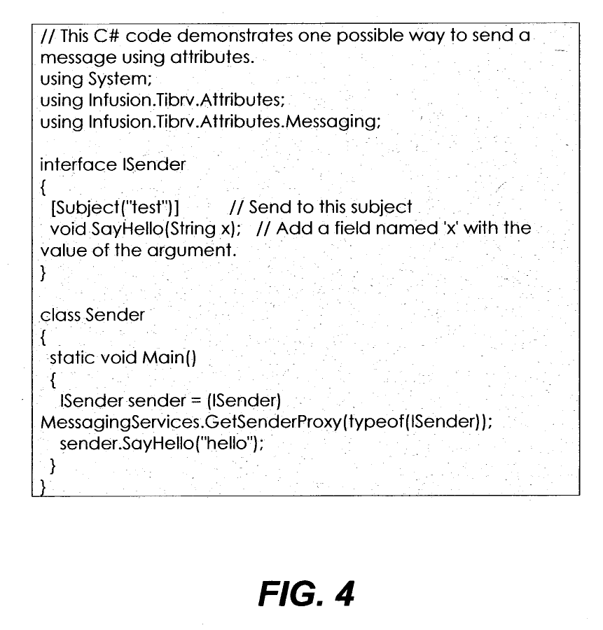

In FIGS. 2 and 4, however, attributes are being used as opposed to APIs. Referring specifically to FIG. 2, the attributes (in bold) translate to the same effect as the direct API calls in FIG. 1. However, their declarative nature reduces almost all the required code and is far easier to work with. As seen in FIG. 2, steps 210 through 220 involve the referencing of the attribute library to insure availability of the attributes.

The attribute “ReliableTransport” indicates that the interface, IPublisher, will be able to listen and send messages on the middleware transport. This is accomplished in few steps than is required by API calling. Steps 100-110 of FIG. 1 are obviated by the attributes method of the present invention. Moreover, the attributes methods allows the user, at step 235, to declare the “SetSubject” attribute which will automatically create a message structure based on the arguments to the functions. This renders unnecessary FIG. 1 steps 125-135. Step 245 is an ordinary class we will use to send messages via IPublisher 250-255) setting up data for sending. Step 260 provides the main block, standard in any program. At step 265, the user passes the attribute-decorated interface IPublisher into a function called “CreateProxy”. This function processes the attributes and returns a new object that will allow the programmer to send and receive messages in an ordinary, natural way (vis a vis a functions of a standard object). Thus, we see that calling the “UpdateStock” method results in a message being created and sent.

The use of attributes in this case is a unique way to render unnecessary direct calling and knowledge of the TIBCO® APIs. Attribute Integration with IBM MQ Series from .NET operates on the identical principal.

The point to keep in mind is that the present method is an elegant way of wrapping a C library for particular middleware in the .NET language C#. This enables the C library to be called from the Net environment. An attribute library can handle and abstract the many API calls that would ordinarily be required to leverage middleware from .NET. To create these inventions it was necessary to analyze the entire middleware library, find mappings from its data types to those data types compatible with .NET. A complete library of attributes that map the functionality of the core vendor-provided middleware libraries had to be designed and implemented that could abstract and automatically handle the details of negotiating with the core libraries.

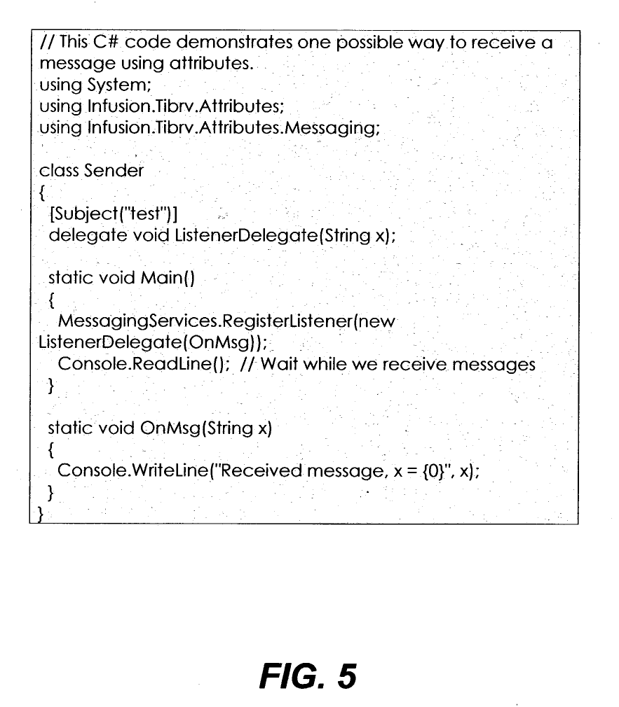

Referring specifically to FIG. 5, there are several ways to send and receive RV messages, but essentially these operations can be grouped into two categories: either a type can be specified and the library will provide an RV-aware implementation of that type (as shown in FIG. 2), or an object reference can be supplied and the library will target that object for RV usage. The latter case is typically used for listeners when a method implementation should be called upon receiving an RV message. FIG. 5 illustrates how the sent message would be received. Notice that the above example passes a reference to a user-defined object (the ListenerDelegate) to the RegisterListener method. This allows the RV Attribute Library (RAL) to keep track of what listener callback method should be invoked when a message arrives on the “test” subject. In general, the RAL exposes two groups of static helper methods on the MessagingServices class, in the form of GetXXProxy and RegisterXX, where XX represents a Listener or Sender.

4.0 Messaging Middleware Architecture Bridging Examples

Though not exhaustive, a preferred architecture and proposed uses for the attribute bridging solution in accordance with the present invention follows. The following discussion illustrates the use of the present bridging solution in one of many middleware environments. The TIBCO middleware environment is used for illustrative purposes only and should in no way be construed as a limitation of the bridging solution. In fact, the bridging solution can be deployed in a wide range of middleware environments to limit a users need to learn additional middleware APIs.

An exemplary embodiment of the present middleware bridging solution provides an interoperability solution between the Microsoft .NET™ platform and the TIBCO Rendezvous™ (RV) messaging system. A developer can use the present bridging solution to quickly and easily build distributed RV applications while exploiting the powerful features of .NET. The system and method consists of the Wrapper and the Attribute Library. The Wrapper provides low-level access to the RV C API through P/Invoke, while the Attribute Library is a high-level declarative API to the Wrapper. .NET provides a mechanism to annotate code elements using keyword-like descriptions called attributes. The Attribute Library offers a set of attributes, which can be used to declaratively specify which features of the RV API to enable. These features include, but are not limited to, sending and receiving reliable or certified messages, enabling fault tolerant operation, or leveraging distributed queues. This programming guide explains the various ways in which the Attribute Library can be used to take advantage of these features.

Although the Attribute Library exposes various features of the RV API, this section will focus on the most commonly anticipated use of the API: sending and receiving messages. In order to best illustrate how the Attribute Library simplifies the development of RV applications, the following code listing shows how to send a message using the Wrapper. The next listing shows how it is done with the Attribute Library.

PSEUDO CODE 4.1:
Sending a message using the Wrapper.

```
// Here is some C# code that demonstrates how to send an RV message
programmatically.
// Error checking omitted for brevity.
using System;
using System.Runtime.InteropServices;
using Infusion.Tibrv.InteropServices;
class Sender
{
  static void Main( )
  {
    tibrv.tibrv_Open( );
    IntPtr transport;
    tibrvTransport.tibrvTransport_Create(out transport, null, null, null);
    IntPtr msg;
    tibrvMsg.tibrvMsg_Create(out msg);
    tibrvMsg.tibrvMsg_SetSendSubject(msg, “test”);
    tibrvMsg.tibrvMsg_AddStringEx(msg, “x”, “hello”, 0);
    tibrvTransport.tibrvTransport_Send(transport.msg);
    tibrvMsg.tibrvMsg_Destroy(msg);
    tibrvTransport.tibrvTransport_Destroy(transport);
    tibrv.tibrv_Close( );
  }
}
```

The following set of pseudo code shows how the same task is accomplished in a more parsimonious manner.

PSEUDO CODE 4.2:
Sending a message using the Attribute Library.

```
// This C# code demonstrates one possible way to send a message
using attributes.
using System;
using Infusion.Tibrv.Attributes;
using Infusion.Tibrv.Attributes.Messaging;
[ReliableTransport]
public interface ISender
{
  [Subject(“test”)] // Send to this subject
  void SayHello(String x); // Add a field named ‘x’ with the value of
  the argument.
}
class Sender
{
  static void Main( )
  {
    ISender sender =
    (ISender)MessagingServices.CreateProxy(typeof(ISender));
    sender.SayHello(“hello”);
  }
}
```

There are several ways to send and receive RV messages, but essentially these operations can be grouped into two categories: either a type can be specified and the Attribute Library will provide an RV-aware implementation of that type (as shown above), or an object reference can be supplied and the Attribute Library will target that object for RV usage. The latter case is typically used for listeners when a method implementation should be called upon receiving an RV message. The following example illustrates how the sent message would be received:

PSUEDO CODE 4.3:
Receiving a message.

```
// This C# code demonstrates one possible way to receive a message using
attributes.
using System;
using Infusion.Tibrv.Attributes;
using Infusion.Tibrv.Attributes.Messaging;
[ReliableTransport]
public class MyListener
{
  [Subject(“test”)]
  public void MyListenerMethod(String x)
  {
    Console.WriteLine(“Listener received: {0}”, x);
  }
  static void Main( )
  {
    MessagingServices.RegisterObject(new MyListener( ));
    Console.ReadLine( ); // Wait while we receive messages
  }
}
```

Notice that the above example passes the reference of an instance of the MyListener class to the RegisterObject method. Upon registration, the Attribute Library will invoke the MyListenerMethod method when a message arrives on the “test” subject. In general, the Attribute Library exposes two overloaded public static methods on the MessagingServices class with the following signatures: (1) Object CreateProxy(Type t); (2) Object CreateProxy(Type t, TibrvAttributeOverrides ao); (3) void RegisterObject(Object o); and (4) void RegisterObject(Object o, TibrvAttributeOverrides ao). The following table summarizes the purpose of each method.

TABLE 4.1

| | |
|---|---|
| Method Signature | Purpose |

RV-enabled implementations dynamically generated by Type

| | |
|---|---|
| Object CreateProxy (Type t) | The type specified as the |
| | argument can be either a |
| | delegate or interface type. If a |
| | delegate type is specified, the |
| | method will return an |
| | implementation which can send |
| | messages. If an interface type is |
| | specified, the method will return |
| | an implementation where |
| | methods on the interface send |
| | messages, and events on the |
| | interface can be used for |
| | receiving messages. |
| | Any other type specified will result |
| | in a runtime exception. |
| Object CreateProxy (Type t, | Identical to the |
| TibrvAttributeOverrides ao) | CreateProxy (Type t) overload, |
| | except that any declaratively |
| | specified attributes on the type |
| | can be dynamically overridden. |
| | The developer can |
| | programmatically specify which |
| | attributes should apply to each |
| | type's members through a |
| | TibrvAttributeOverrides |
| | object. |

TABLE 4.2

| | |
|---|---|
| Method Signature | Purpose |

User-created objects which can be RV-enabled through registration

| | |
|---|---|
| void RegisterObject (Object o) | The argument passed should |
| | be an instance of a class or |
| | delegate, which has been |
| | annotated with the desired RV |
| | attributes. If a delegate |
| | instance is specified, the |
| | instance will act as a listener |
| | and be invoked whenever a |
| | message arrives on the |
| | specified subject. If a class |
| | instance is specified, public |
| | instance methods with a |
| | SubjectAttribute specified |
| | will be able to receive |
| | messages, while public |
| | instance events with a |
| | SubjectAttribute will be |
| | capable of sending messages. |
| void RegisterObject (Object o, | Operates identically to |
| TibrvAttributeOverrides ao) | RegisterObject (Object o), |
| | but uses dynamically specified |
| | attribute information through |
| | the |
| | TibrvAttributeOverrides |
| | parameter. |
| void UnregisterObject (Object o) | Used to disable RV capability |
| | on an object previously |
| | enabled through a |
| | RegisterObject call. |

Using the Attribute Library comprises the following three steps. The User must define the type(s) to be used for sending/receiving messages: The Attribute Library can work with any publicly defined interfaces, delegates and classes. For interfaces and classes, the public (instance) methods and events annotated with a SubjectAttribute define the mechanisms for sending and receiving RV messages. The roles of methods and events on interfaces and classes are reversed: methods act as senders on interfaces and events act as senders on classes, while events act as receivers on interfaces and methods act as receivers on classes. Delegates will act as senders when used with CreateProxy, and delegate instances will act as receivers when used with RegisterObject.

The User must also, annotate the type(s) with attributes from the Attribute Library to specify how they should be used with the underlying messaging infrastructure (RV). The SubjectAttribute is a mandatory attribute and must be applied to any methods, events or delegates. All other attributes are optional. Usually, however, a ReliableTransport attribute is applied at the type level to allow messaging to occur over the network (the absence of this attribute causes the intra-process transport to be used). An additional step comprises the use of the annotated types within an application: All types or instances must first be associated with the Attribute Library through either the CreateProxy or RegisterObject method of the MessagingServices class. Once this step is complete, the object can be used to send and receive messages within an application.

The following table illustrates how different types can be used with CreateProxy or RegisterObject to send and receive messages:

TABLE 4.3

| Construct | CreateProxy | RegisterObject |
|---|---|---|
| Delegate | Sender | Receiver |
| Interface Method | Sender | N/A |
| Interface Event | Receiver | N/A |
| Class Method | N/A | Receiver |
| Class Event | N/A | Sender |

Note, in this embodiment, that the Attribute Library only works with public instance methods or events—it ignores any static or non-public constructs. The following examples clarify how each of the constructs (i.e., delegates, interfaces, classes etc) may be used to send and receive messages.

### EXAMPLE 4.1

### Sending & Receiving Messages Using Delegates

Sending Messages

```
// This C# code demonstrates how to send a message using a delegate.
using System;
using Infusion.Tibrv.Attributes;
using Infusion.Tibrv.Attributes.Messaging;
[ReliableTransport]
[Subject(“test”)]
public delegate void SayHello(String message);
class Sender
{
  static void Main( )
  {
    SayHello s =
(SayHello)MessagingServices.CreateProxy(typeof(SayHello));
    s(“Hello”);
  }
}
```

Receiving Messages

```
// This C# code demonstrates how to receive the message sent above
using a delegate.
using System;
using Infusion.Tibrv.Attributes;
using Infusion.Tibrv.Attributes.Messaging;
[ReliableTransport]
[Subject(“test”)]
public delegate void HelloDelegate(String message);
class Receiver
{
  static void MyHello(String msg)
  {
    System.Console.WriteLine(msg);
  }
  static void Main( )
  {
    MessagingServices.RegisterObject(new HelloDelegate(MyHello));
    Console.ReadLine( ); // Wait while we receive messages
  }
}
```

### EXAMPLE 4.2

### Sending & Receiving Messages Using Interfaces

Sending Messages

```
// This C# code demonstrates how to send messages using an interface.
using System;
using Infusion.Tibrv.Attributes;
using Infusion.Tibrv.Attributes.Messaging;
[Transport]
public interface IFoo
{
  [Subject(“test”)]
  void SayHello(String x);
}
class Sender
{
  static void Main( )
  {
    IFoo f = (IFoo)MessagingServices.CreateProxy(typeof(IFoo));
    f.SayHello(“hello”);
  }
}
```

Receiving Messages

```
// This C# code demonstrates how to receive the message sent above using
an interface.
using System;
using Infusion.Tibrv.Attributes;
using Infusion.Tibrv.Attributes.Messaging;
public delegate void MyDelegate(string x);
[ReliableTransport]
public interface IFoo
{
  [Subject(“test”)]
  event MyDelegate MyEvent;
}
class Receiver
{
  static void OnHello(String x) // The method name is irrelevant,
  parameters are not
  {
    Console.WriteLine(x);
  }
  static void Main( )
  {
    IFoo f = (IFoo)MessagingServices.CreateProxy(typeof(IFoo));
    f.MyEvent += new MyDelegate(OnHello);
    Console.ReadLine( ); // OnHello will be called whenever a message
    arrives
  }
}
```

### EXAMPLE 4.3

### Sending & Receiving Messages Using Delegates

Sending Messages

```
// This C# code demonstrates how to send messages using a class event.
using System;
using Infusion.Tibrv.Attributes;
using Infusion.Tibrv.Attributes.Messaging;
public delegate void MyDelegate(String x);
[Transport]
public class Sender
{
  [Subject(“test”)]
  public event MyDelegate MyEvent;
  static void Main( )
  {
    Sender s = new Sender( );
    MessagingServices.RegisterObject(s);
    s.MyEvent(“hello”);
  }
}
```

Receiving Messages

```
// This C# code demonstrates how to receive messages using a class
method.
using System;
using Infusion.Tibrv.Attributes;
using Infusion.Tibrv.Attributes.Messaging;
[ReliableTransport]
public class Receiver
{
  [Subject(“test”)]
  public void OnMsg(String x)
  {
  Console.WriteLine(x);
  }
  static void Main( )
  {
    MessagingServices.RegisterObject(new Receiver( ));
    Console.ReadLine( );
  }
}
```

Regardless of whether one uses type-based dynamic proxy generation or registers an existing object for RV operations, the way RV will be used depends on the attributes specified for a given construct. The following sections discuss how these attributes can be used and what attributes are available for performing various RV operations.

5.0 Messaging Attributes

Each time an RV-enabled construct is used, the Attribute Library needs to know how to set up the RV layer to send and receive messages. For example, when a method is called on an interface, the Attribute Library needs to determine basic sending parameters such as the transport to use, the message send subject and the fields to include. All of these operational parameters are specified in attributes and the method signature. In some instances, these attributes may be specified directly on the construct used (e.g. on the method itself), or on the declaring type (e.g. on the interface). In other instances, the attributes may be specified in an XML configuration file, or may simply be omitted in which case the defaults will be used. Regardless of the location of the metadata, the Attribute Library needs to know how to resolve this metadata for any given construct that may be used. In NET terminology, the constructs that are associated with metadata are referred to as attributes targets. The following table lists the various scenarios where metadata for any given attribute target may be resolved.

TABLE 5.1

| Metadata location | Description | Example |
|---|---|---|
| Attribute | Some attributes are optional. If an | If the Transport attribute is |
| unspecified | attribute is not specified, defaults will | not specified, the intra- |
| | be assumed. | process transport will be |
| | | assumed. |
| Attribute applied | Attributes may be applied directly to a | [ReliableTransport] |
| directly to target | method, event, delegate, class or | public interface IFoo |
| | interface. For interfaces and classes, | { |
| | attributes generally fall into one of two | [Subject (“test”)] |
| | categories: type level attributes and | void Method(); |
| | method or event level attributes. | } |
| | Attributes from both categories can be | [ReliableTransport] |
| | applied to delegates, although some | public class Foo |
| | attributes do not make sense on a | { |
| | delegate (e.g. the | [Subject (“test”)] |
| | FaultTolerantGroupMember | public void f (int x) |
| | attribute). | { |
| | | } |
| | | } |
| XML | In order to support configuration | [Subject (“test”, |
| Configuration data | without recompiling the application, it | ConfigID=“appSubject”)] |
| pointed to by | is also possible to specify metadata in | interface IFoo |
| attribute | an external XML configuration file. | { |
| | The XML configuration file complies | void Method(); |
| | with the .NET configuration facility. | } |
| | The example shows how a subject can | |
| | be specified either directly in the | |
| | attribute or through the configuration | |
| | file. The configuration file value will | |
| | take precedence over an inline- | |
| | specified value. | |

When a type is registered with the Attribute Library to enable RV usage, it is expected that the type itself will contain all the necessary metadata (or point to a configuration file). Types should be used as expected by the Attribute Library—for example, do not use a class instance which implements an interface decorated with attributes. The preferred order of precedence for determining metadata values that apply to a given target are generally as follows: (1) If an attribute exists directly on the target and a configuration ID is specified, the value(s) in the application configuration file will be used; (2) If there is no configuration property specified (or it cannot be resolved), then the inline attribute value will be used. Attributes can be inherited from base members; and (3) If no attribute value was found, then a given attribute will assume its default values. If no default exists, a runtime exception will be thrown.

Once an attribute has been specified in code and compiled, the values associated with the attribute cannot be changed at runtime. In essence, they are hard-coded at development time. However, there are cases where attribute values may need to be dynamically overridden at runtime. The Attribute Library provides a way to associate dynamically specified attribute values with attribute targets. Here is an example of how one may dynamically specify all attributes for a given type:

### EXAMPLE 5.1

### Using the Attribute Override Facility

```
public interface IFoo
{
  void Go(string s);
}
class DynamicSample
{
  static void Main( )
  {
    TibrvAttributes attribs = new TibrvAttributes( );
    TibrvAttributeOverrides ao = new TibrvAttributeOverrides( );
    attribs.ReliableTransport = new ReliableTransportAttribute( );
    ao.Add(typeof(IFoo), attribs);
    attribs.Subject = new SubjectAttribute(“test”);
    ao.Add(typeof(IFoo), “Go”, attribs);
    IFoo f = (IFoo)MessagingServices.CreateProxy(typeof(IFoo), ao);
    f.Go(“hello”);
  }
}
```

As shown in the example above, the type does not need to be annotated with any attributes at all, instead they are created dynamically and passed to the Attribute Library upon creating the proxy. The TibrvAttributes class provides a container for specifying the desired attributes, while the TibrvAttributeOverrides class allows those attributes to become associated with a particular attribute target (class, interface, delegate, method, or event). Once all required attributes have been dynamically specified, the appropriate overload of CreateProxy or RegisterObject can be called with the new configuration settings.

6.0 Configuration XML

The configuration XML is based on .NET's configuration facility, and as such the file should be named appname.config, where appname is the full executable assembly file name (not including the path).

All configuration elements are placed within the <tibrvconfig> tag. The Attribute Library provides a configuration section handler to parse the elements within. Take an application configuration file such as the one listed below:

```
  <configuration>
  <configSections>
    <section
      name=“tibrvConfig”
      type=“Infusion.Tibrv.Attributes.Config.ConfigSectionHandler,
            Infusion.Tibrv.Attributes”/>
  </configSections>
  <tibrvConfig file=“user.config”
    xmlns=“http://www.infusiondev.com/tibrvAttributes”
    xmlns:xsi=“http://www.w3.org/2001/XMLSchema-instance”>
    <!-- configuration elements go here -->
  </tibrvConfig>
</configuration>
```

the <tibrvconfig> element has an optional file attribute which can be used to specify an alternative configuration file to load. If the alternative file exists, the contents of that file will be used instead of the RV configuration data found in the main application configuration file. This works in the same way as .NET's <appsettings> element.

Every attribute supports the ability to point to externally defined metadata in the application configuration file through the configID property. The value of this property indicates where in the configuration file to find the metadata values to use for the attribute target. It is optional to specify the ConfigID property, but if specified the Attribute Library will lookup values in the configuration file. If the XML element with the specified ID could not be found, then the attribute will assume all default values if supported.

Every XML configuration element must have a ConfigID attribute as well as a set of other configuration-specific attributes or child elements. Some attributes may be absent, while others may be present but explicitly defined as null. The semantics for the configuration XML is defined as follows:

The absence of a top-level element (e.g. a missing <transport> element) indicates that the .NET attribute should assume all default values. If specifying the .NET attribute is mandatory and the element is missing, a runtime exception occurs.

If an XML attribute is missing, the corresponding .NET attribute parameter will take on the default value.

If a child XML element is missing, the corresponding .NET attribute parameter will take on the default value.

If a child XML element is specified but indicates the null attribute, xsi:nil=‘true’, then the corresponding .NET attribute will also be set to null. This value is only valid for reference data types, not value types.

The null attribute should be from the namespace for schema instances. For example, if the namespace prefix were “xsi”, then the following namespace definition should be present:

xmlns:xsi=“http://www.w3.org/2001/XMLSchema-instance”

7.0 Data Mapping and Conversions

Whenever a message is sent or received, the Attribute Library maps values to and from method signatures to message fields. The following table shows the mapping between data types defined in a method signature and the corresponding data type used for the RV message field.

TABLE 7.1

| Method Parameter Type | RV Message Field Type |
|---|---|
| Boolean | TIBRVMSG_BOOL |
| DateTime | TIBRVMSG_DATETIME |
| SByte | TIBRVMSG_I8 |
| Int16 | TIBRVMSG_I16 |
| Int32 | TIBRVMSG_I32 |
| Int64 | TIBRVMSG_I64 |
| Byte | TIBRVMSG_U8 |
| UInt16 | TIBRVMSG_U16 |
| UInt32 | TIBRVMSG_U32 |
| UInt64 | TIBRVMSG_U64 |
| Single | TIBRVMSG_F32 |
| Double | TIBRVMSG_F64 |
| SByte[] | TIBRVMSG_I8ARRAY |
| Int16[] | TIBRVMSG_I16ARRAY |
| Int32[] | TIBRVMSG_I32ARRAY |
| Int64[] | TIBRVMSG_I64ARRAY |
| Byte[] | TIBRVMSG_U8ARRAY |
| UInt16[] | TIBRVMSG_U16ARRAY |
| UInt32[] | TIBRVMSG_U32ARRAY |
| UInt64[] | TIBRVMSG_U64ARRAY |
| Single[] | TIBRVMSG_F32ARRAY |
| Double[] | TIBRVMSG_F64ARRAY |
| String | TIBRVMSG_STRING |
| (user-defined type) | TIBRVMSG_MSG |

When sending a message, the following takes place: (1) A message field is added for each method parameter; (2) The field name will be a string equal to the parameter name; (3) Numeric field identifiers will not be used (5) The field value will equal the argument value; (6) The data type is set according to the mapping table; and (7) The send and reply subject (if applicable) are set and the message is sent.

When receiving a message, the following takes place:

Based on each parameter in the method signature, the corresponding field is retrieved from the RV message.

The field name corresponds to the parameter name.

The expected data type corresponds to the mapping specified in the mapping table.

An argument array is created with the values and the method associated with the event is invoked.

Although direct one-to-one mappings exist between the .NET and RV data types, there is still some overhead for marshaling the data between the managed and unmanaged heaps. For some types, there is even more overhead due to implicit conversions. For example, String types actually undergo an ANSI/Unicode codepage translation between the RV API and the .NET methods. The codepage used depends on the system default, but more importantly this means that any Strings, which cannot be properly converted will be transmitted as garbled data. In order to ensure safe transmission of Unicode strings, the field should be encoded to UTF-8 and sent as a byte array.

A subset of .NET Common Type System (CTS) types have no direct mapping to RV data types, however. The following table lists these types and the suggested substitute data types. Note that array types containing these types are also unsupported directly, and some types have no equivalent as they may not make sense outside their native context.

TABLE 7.2

| Unsupported | Substitute | |
|---|---|---|
| CTS Type | CTS Type | Resulting RV Type |
| Char | UInt16 | TIBRVMSG_U16 |
| Decimal | String | TIBRVMSG_OPAQUE |
| IntPtr | N/A | N/A |
| UIntPtr | N/A | N/A |
| TypedReference | N/A | N/A |

A subset of RV message types current have no direct mapping to any CTS type. For cases where such functionality is needed, the Wrapper should be used:

TABLE 7.3
RV Message Field Type
TIBRVMSG_XML
TIBRVMSG_OPAQUE
TIBRVMSG_IPADDR32
TIBRVMSG_IPPORT16
TIBRVMSG_MSG

8.0 Custom Data Types

When sending and receiving messages, user-defined data types may be used. The serialization and deserialization characteristics of a given type are determined by the XmlSerializer class from the System.Xml.Serialization namespace. As a result, the following features are automatically provided, namely, (1) the ability to specify types with complex hierarchies (directly mapping to hierarchical RV messages); (2) any public instance fields or properties are serialized while maintaining type fidelity (as per XSD types). A type's members should not have any security attributes as this will cause problems with the serializer; (3) the VS.NET XML Schema designer may be used to design messages and their data structures. The .NET XSD tool may be used to generate the classes from these schemas; and (4) serialization and deserialization can be controlled by using the XSD-based (non-SOAP) attributes found in the System.Xml.Serialization namespace. For example, the name of an RV field can be controlled using the XmlElementAttribute's ElementName property.

9.0 Sending and Receiving DataSets

A DataSet can be sent and received over the TIB simply by specifying the type as a formal parameter in a method signature using for sending or receiving. The. XML format of the DataSet determines the RV message structure, and in general may only be useful by senders and receivers using the Attribute Library. However, the RV message can still be parsed by a listener in any application without having to know about the details of a DataSet.

10.0 Attributes Specification

The following section summarizes many attributes available in the Attribute Library, and includes examples where appropriate.

10.1 Reliable Transport Attribute

TABLE 10.1.1
Characteristics

| Name | ReliableTransportAttribute |
|---|---|
| Description | Use this attribute to configure the service, |
| | network and daemon parameters used in |
| | sending or receiving messages. |
| Targets | Classes, interfaces, delegates. |
| Inheritable | Yes |
| Allow multiple on a target | No |
| Mandatory | No. If not found, will use intra-process |
| | transport. |

TABLE 10.1.2
Positional Parameters

| Name | Type | Description | Default |
|---|---|---|---|
| Service | String | The UDP service port on which the | null (UDP |
| | | transport will communicate. | 7500) |
| Network | String | The network parameter for the RV | null (local |
| | | transport | settings) |
| Daemon | String | The TCP host/port to use for | null (local |
| | | connecting to the daemon. | daemon at |
| | | | TCP 7500) |

TABLE 10.1.3
Named Properties

| Name | Type | Description | Default |
|---|---|---|---|
| Description | String | The description string to set on the | null |
| | | transport. | |
| LicenseTicket | String | The embedded license ticket to | null |
| | | use for the transport. | |
| ConfigID | String | The id in the XML configuration | null |
| | | corresponding to this attribute. | |

### XML Configuration 10.1

```
<reliableTransports>
  <reliableTransport>
    id=“ConfigID”
    service=“RV service”
    network=“RV network”
    daemon=“RV daemon”>
    <description>transport description</description>
    <licenseTicket>embedded license ticket string</licenseTicket>
  </reliableTransport>
</reliableTransport>
```

### EXAMPLE 10.1

```
// A C# snippet illustrating the use of ReliableTransportAttribute
[ReliableTransport(“8100”, null, “tcp:9100”, ConfigID=“tport1”)]
public interface IFoo
{
  [Subject(“hello”)]
  void Foo(Int32 x);
}
class Test
{
  // The Go method will effectively send an RV message on
  // the subject “Hello”, using the transport parameters
  // specified for the IFoo interface. If an application
  // configuration file exists, it will be used instead.
  void Go( )
  {
    IFoo f = (IFoo)MessagingServices.CreateProxy(typeof(IFoo));
    f.Foo(123);
  }
}
/*
If a configuration file is used, here is how the transport metadata
should be specified:
<reliableTransport id=“tport1” service=“8100” daemon=“tcp:9100”/>
*/
```

10.2 Subject Attribute

TABLE 10.2.1
Characteristics

| Name | SubjectAttribute |
|---|---|
| Description | For senders, this specifies what subject to send to |
| | when invoking a method. For listeners, this |
| | specifies what subject to listen on. |
| Targets | Delegates, events, methods |
| Inheritable | Yes |
| Allow multiple on a | No |
| target | |
| Mandatory | Yes. A runtime exception will occur if no subject |
| | attribute exists. |

TABLE 10.2.2
Optional Positional Parameters

| Name | Type | Description |
|---|---|---|
| Name | String | The subject name to send to or listen on. Listener |
| | | methods may receive messages with reply |
| | | subjects, in which case the reply subject will |
| | | become associated with the listener method's |
| | | thread. A message may then be sent to the reply |
| | | subject by calling another method (on the same |
| | | thread) with its Subject attribute using the default |
| | | constructor. |

TABLE 10.2.3
Named Properties

| Name | Type | Description | Default |
|---|---|---|---|
| Inbox | Boolean | This property applies to listener methods | false |
| | | only. If true, the subject Name will | |
| | | identify which inbox to listen on for | |
| | | events. Since an inbox only makes | |
| | | sense when using it as the reply subject | |
| | | of an outbound message, this property | |
| | | must be used in conjunction with a | |
| | | sender method, which specifies the | |
| | | ReplySubject attribute with its Inbox | |
| | | property also set to true. | |
| AnticipatedListeners | String[ ] | Applies to certified messaging senders | null |
| | | only. Specifies the names of the | |
| | | persistent CM correspondents listening | |
| | | for messages sent on this subject. | |
| | | If null, the sender will not store | |
| | | outbound messages for an unregistered | |
| | | listener. Otherwise, any backlogged | |
| | | outbound messages will be resent to the listener | |
| | | if it has set its CertifiedTransport attribute's | |
| | | RequestOld property to true. | |
| ConfigID | String | The id in the XML configuration | null |
| | | corresponding to this attribute. | |

### XML Configuration 10.2

```
<subjects>
  <subject
    id=“ConfigID”
    name=“subject name”>
    <inbox>true | false</inbox>
    <persistAgreements>true | false</persistAgreements>
    <anticipatedListeners>
      <anticipatedListener>persistent CM name</anticipatedListener>
    </anticipatedListeners>
  </subject>
</subjects>
```

If a message is sent from a listener method, which received a message with a reply subject, then the Subject attribute on the sending method should use the default constructor in order to send to the reply subject. Method signatures should have a return type of void for publish/subscribe scenarios. Any other return types imply a request/reply interaction any will result in a synchronous call. When sending or listening, the message signature determines the fields of the message. It is possible that a received message may have more or less fields, or fields that do not match the method signature. In such cases, the method call will not be dispatched. See the CertifiedTransport attribute for details on using the Subject's named properties related to certified messaging.

### EXAMPLE 10.2

```
// This C# snippet illustrates how to use a reply subject.
[ReliableTransport]
public interface IFoo
{
  [ReplySubject(“reply.subject”)]
  [Subject(“hello”)]
  void SendRequest(Int32 x);
}
class SendWithReply
{
  static void Main()
  {
    IFoo f = (IFoo)MessagingServices.CreateProxy(typeof(IFoo));
    f.SendRequest(123);
  }
}
```

10.3 Reply Subject Attribute

TABLE 10.3.1
Characteristics

| Name | ReplySubjectAttribute |
|---|---|
| Description | This attribute applies to senders only, and |
| | is used to specify the reply subject to use |
| | when sending messages. |
| Targets | Delegates, events, methods |
| Inheritable | Yes |
| Allow multiple on a target | No |
| Mandatory | No. If unspecified, no reply subject will be |
| | set on sent messages. |

TABLE 10.3.2
Mandatory Positional Parameters

| Name | Type | Description |
|---|---|---|
| Name | String | The reply subject name used for outbound |
| | | messages. |

TABLE 10.3.3
Named Properties

| Name | Type | Description | Default |
|---|---|---|---|
| Inbox | Boolean | If true, an inbox will be | false |
| | | created and the actual reply | |
| | | subject name will be the inbox | |
| | | name. The Name parameter | |
| | | specified for the ReplySubject | |
| | | is used internally by the | |
| | | Attribute Library to identify the | |
| | | inbox. Listener methods can | |
| | | then listen on this inbox by | |
| | | using this same identifier as | |
| | | the Name parameter of the | |
| | | Subject attribute with its Inbox | |
| | | property also set to true. | |
| ConfigID | String | The id in the XML | null |
| | | configuration corresponding | |
| | | to this attribute. | |

### XML Configuration 10.3

```
<replySubjects>
  <replySubject
    id=“ConfigID”
    name=“reply subject name”>
    <inbox>true | false</inbox>
  </replySubject>
</replySubjects>
```

10.4 Queue Attribute

TABLE 10.4.1
Characteristics

| Name | QueueAttribute |
|---|---|
| Description | This attribute applies to listeners only. In |
| | order to use a separate queue for storing |
| | events, this attribute must be used. This |
| | attribute allows for configuring the queue |
| | priority, capacity and limit policy. In |
| | addition, the queue can be specified to |
| | be a group member to enable priority |
| | dispatching of methods. |
| Targets | Events, methods |
| Inheritable | Yes |
| Allow multiple on a target | No |
| Mandatory | No. If unspecified, the events for a method |
| | will be stored in the default queue. |

TABLE 10.4.2
Mandatory Positional Parameters

| Name | Type | Description |
|---|---|---|
| Name | String | Specifies a queue name for |
| | | identification purposes in admin |
| | | tools. Although the RV API does |
| | | not enforce a queue name, this |
| | | parameter is enforced to assist in |
| | | troubleshooting queues. |
| | | To explicitly indicate the default |
| | | queue, specify null. Note that the |
| | | omission of this attribute implies |
| | | the default queue. |

TABLE 10.4.3
Optional Positional Parameters

| Name | Type | Description | Default |
|---|---|---|---|
| Priority | Int32 | Sets a queue priority. | 1 |
| | | When a queue is part | |
| | | of a group, it will be | |
| | | dispatched according | |
| | | to its priority. A higher | |
| | | priority queue will | |
| | | dispatch before a | |
| | | lower priority queue. | |
| | | Priority zero indicates | |
| | | last dispatch. Negative | |
| | | values will result in a | |
| | | runtime exception. | |
| | | If the priority of a | |
| | | given queue | |
| | | is changed on | |
| | | different Queue | |
| | | attributes, only | |
| | | the first | |
| | | specified will take | |
| | | effect. | |
| LimitPolicy | QueueLimitPolicy | Specifies what action | DiscardNone |
| | | to take when | |
| | | a queue exceeds | |
| | | its capacity. | |
| MaxEvents | Int32 | Specifies the queue | 0 |
| | | capacity. The default | |
| | | (0) specifies the queue | |
| | | can hold an unlimited | |
| | | number of events. | |
| | | The intra-process | |
| | | transport will present a | |
| | | warning advisory if the | |
| | | limit is exceeded. | |
| DiscardAmount | Int32 | Specifies the number | 0 |
| | | of events to | |
| | | discard if the | |
| | | maximum number of | |
| | | events is reached. | |

TABLE 10.4.4
Named Properties

| Name | Type | Description | Default |
|---|---|---|---|
| GroupName | String | The name of the queue group | null |
| | | that this queue is a member of. | |
| | | Queues within a group are | |
| | | dispatched by a single | |
| | | dispatcher, by priority. | |
| | | By default, the queue is not | |
| | | part of any group and has its | |
| | | own dispatcher. | |
| ConfigID | String | The id in the XML configuration | null |
| | | corresponding to this attribute. | |

### XML Configuration 10.4

```
<queues>
  <queue
    id=“ConfigID”
    name=“queue name”
    priority=“non-negative priority”
    limitPolicy=“discardNone | discardNew | discardFirst |
discardLast”
    maxEvents=“non-negative number”
    discardAmount=“non-negative number”>
    <groupName>queue group name</groupName>
  </queue>
</queues>
```

Queues will hold messages, which will result in dispatching listener methods or events. In a preferred embodiment, (1) each queue has exactly 1 dispatcher; (2) there can be multiple event listeners per queue, but each listener is associated with one subject (which can use wildcards) and one queue only; (3) a dispatcher can work on multiple queues through a group; and (4) a queue can hold messages for multiple methods/events. The limit policy specified should comply with the RV API requirements. The following table summarizes the policy rules defined in the QueueLimitPolicy enumeration:

TABLE 10.4.5
Constraints for setting queue limits

| | Required Discard | |
|---|---|---|
| Policy Setting | Amount | Required Max Events |
| DiscardNone | 0 | 0 |
| DiscardNew | 1 | >= DiscardAmount |
| DiscardFirst | >= 0 | >= DiscardAmount |
| DiscardLast | >= 0 | >= DiscardAmount |

### EXAMPLE 10.4

```
// This C# snippet shows how to dispatch to methods by priority.
[ReliableTransport]
public class PriorityDispatch
{
  internal void SetupListener( )
  {
    // A single dispatcher will work on the “myGroup” queue group
    // The HighPriority method will be called more often since
    // its priority is higher than LowPriority's queue.
    MessagingServices.RegisterObject(this);
  }
  [Subject(“test”)]
  [Queue(“q1”, 10,
    QueueLimitPolicy.DiscardNone, 0, 0, GroupName=“myGroup”)]
  public void HighPriority(String s)
  {
    Console.WriteLine(s);
  }
  [Subject(“test”)]
  [Queue(“q2”, 1,
    QueueLimitPolicy.DiscardNone, 0, 0, GroupName=“myGroup”)]
  public void LowPriority(Int32 x)
  {
    Console.WriteLine(x);
  }
}
```

10.5 Certified Transport Attribute

TABLE 10.5.1
Characteristics

| Name | CertifiedTransportAttribute |
|---|---|
| Description | This attribute can be used to enable |
| | sending and receiving certified messages. |
| | Certified messaging features such as |
| | ledgers, requesting old messages and CM |
| | message timeouts can be configured with |
| | this attribute. |
| Targets | Classes, Interfaces, Delegate |
| Inheritable | Yes |
| Allow multiple on a target | No |
| Mandatory | No. If unspecified, reliable messaging will |
| | be used instead. |

TABLE 10.5.2
Optional Positional Parameters

| Name | Type | Description | Default |
|---|---|---|---|
| Name | String | Sets a name for a persistent | null |
| | | correspondent. This name must | |
| | | comply with the requirements | |
| | | for valid RV CM | |
| | | transport names. | |
| | | If null, a unique transient | |
| | | correspondent name will be | |
| | | generated and used. | |
| LedgerName | String | Specifies the file name to use | null |
| | | for a persistent ledger. | |
| | | If null, a transient process-based | |
| | | ledger will be used. | |
| MessageTimeLimit | Double | This value sets the default | 0 |
| | | message time limit for all | |
| | | outbound certified messages. | |
| | | Upon expiry, the sender will no | |
| | | longer certify delivery. | |
| | | A value of zero indicates | |
| | | no time limit. | |

TABLE 10.5.3
Named Properties

| Name | Type | Description | Default |
|---|---|---|---|
| RequestOld | Boolean | Applies to CM listeners only. | false |
| | | If this property is true, | |
| | | the CM transport | |
| | | will request re-delivery of certified | |
| | | messages for which delivery was | |
| | | not confirmed. | |
| RemoveSendState | Boolean | Upon completion of certified | false |
| | | message delivery, the send state for | |
| | | any subjects sent on this transport | |
| | | will be purged. This is intended to | |
| | | minimize the growth of the ledger | |
| | | over time for dynamically specified | |
| | | subjects such as when replying to | |
| | | inboxes. | |
| | | This feature is currently | |
| | | not implemented. | |
| ConfigID | String | The id in the XML configuration | null |
| | | corresponding to this attribute. | |

### XML Configuration 10.5

```
<certifiedTransports>
  <certifiedTransport
    id=“ConfigID”
    name=“CM persistent correspondent name”
    ledgerName=“file name for persistent ledger”>
    <requestOld>true | false</requestOld>
    <messageTimeLimit>time limit (seconds)</messageTimeLimit>
  </certifiedTransport>
</certifiedTransports>
```

Certified messaging behavior is determined by the CM API. Therefore, the first method call will not use a certified delivery agreement unless the sender anticipates the listener, and the listener requests old messages. If listeners are pre-registered through the AnticipatedListeners property of the Subject attribute and listener transports specify the true for the RequestOld property of the CertifiedTransport attribute, the discovery and registration process can be skipped and all messages can be delivered as certified.

When using certified messenger, the sender correspondent name should not be the same as the listener correspondent name. Moreover, the listener correspondent should request old messages and specify a reusable name (do not specify null for the name and request old messages). Additionally, the sender should anticipate each of its expected certified listeners to ensure certified delivery of the first message. Otherwise the discovery and registration process are required and the first message will not be certified. Note that certified listeners will also process reliable messages. This will result in non-certified invocation of listener method callbacks.

### EXAMPLE 10.5

```
// This C# snippet shows how to send and receive certified messages.
// A persistent correspondent that sends certified messages
[ReliableTransport]
[CertifiedTransport(“cmsender”)]
public interface IFoo
{
  [Subject(“test”, AnticipatedListeners=new String[]{“cmlistener”})]
  void Foo(String x);
}
class CertifiedSender
{
  void SendMessage( )
  {
    IFoo f = (IFoo)MessagingServices.CreateProxy(typeof(IFoo));
    f.Foo(“hello”);
  }
}
// A persistent correspondent that receives certified messages
[ReliableTransport]
[CertifiedTransport(“cmlistener”, RequestOld=true)]
public class CertifiedListener
{
  public CertifiedListener( )
  {
    MessagingServices.RegisterObject(this);
  }
  [Subject(“blah”)]
  public void OnMsg(String x)
  {
    Console.WriteLine(x);
  }
}
```

10.6 Fault Tolerant Member Attribute

TABLE 10.6.1
Characteristics

| Name | FaultTolerantMemberAttribute |
|---|---|
| Description | Use this attribute to participate in a fault |
| | tolerant (FT) group. This attribute can only |
| | be applied to classes which implement |
| | the IFtMember interface, which provides |
| | notifications to the member concerning |
| | changes to the FT group. |
| Targets | Classes |
| Inheritable | Yes |
| Allow multiple on a target | No |
| Mandatory | No. If unspecified, instances of the class |
| | will not be FT aware. Note that this |
| | attribute should not be used if the |
| | Distributed Queue attribute is used, as |
| | they are both mutually exclusive. |

TABLE 10.6.2
Mandatory Positional Parameters

| Name | Type | Description |
|---|---|---|
| Name | String | Specifies the name of the fault |
| | | tolerant group to join. |
| Weight | Int16 | This value is used by RVFT to |
| | | determine which member to |
| | | activate within a group. The higher |
| | | the value relative to other group |
| | | members, the more likely it will be |
| | | selected for activation. |
| | | This value should be greater than |
| | | zero, which is a reserved value. |
| ActiveGoal | Int16 | Specifies the number of active |
| | | members to maintain within the |
| | | group. |
| | | This value should be greater than |
| | | zero. |
| HeartbeatInterval | Double | Specifies the interval (in seconds) at |
| | | which active members send out |
| | | heartbeat signals. |
| | | This value should be greater than |
| | | zero. |
| PreparationInterval | Double | Specifies the minimum amount of |
| | | time (in seconds) before ranking |
| | | inactive members are given a |
| | | chance to prepare to activate |
| | | once it has been detected that the |
| | | number of active members in the |
| | | group falls below the active goal. |
| ActivationInterval | Double | Specifies the interval (in seconds) |
| | | after detecting a lost active |
| | | member when the ranking inactive |
| | | member of a group will become |
| | | active. |

TABLE 10.6.3
Named Properties

| Name | Type | Description | Default |
|---|---|---|---|
| ConfigID | String | The id in the XML configuration | null |
| | | corresponding to this attribute. | |

### XML Configuration 10.6

```
<faultTolerantMembers>
  <faultTolerantMember
    id=“ConfigID”
    name=“FT group name”
    weight=“FT member weight”
    activeGoal=“FT active goal”
    heartbeatInterval=“FT heartbeat interval (seconds)”
    preparationInterval=“FT preparation interval (seconds)”
    activationInterval=“FT activation interval (seconds)” />
</faultTolerantMembers>
```

### Interfaces 10.6

| public interface IFtMember | |
|---|---|
| { | |
| void Notify(String groupName, FtMemberAction action); | |
| } | |
| public enum FtMemberAction | |
| { | |
| PrepareToActivate | = 1, |
| Activate | = 2, |
| Deactivate | = 3 |
| } | |

Changes within an FT group are communicated to FT members via the IFtMember interface. Instances within an FT group will be notified with one of the three possible FT actions (prepare to activate, activate, and deactivate). The FT object should take appropriate action depending on the change notification received for the group.

The FaultTolerantMember attribute must be used in conjunction with the ReliableTransport attribute. The reliable transport is used to handle FT communications such as heartbeats. If the transport is not specified, the intra-process transport will be used and will defeat the purpose of fault-tolerant operations. The default queue will be used to collect FT messages unless a Queue attribute is explicitly specified. It is the responsibility of the object to ensure that the appropriate action is taken upon receiving notifications within the FT group (via the IFtMember interface).

### EXAMPLE 10.6

```
// This C# snippet demonstrates an FT timestamp publisher
[ReliableTransport]
[FaultTolerantMember(“ft1”)] // Use FT defaults
public class FtSender : IFtMember
{
  delegate void FooDelegate(DateTime dt);
  [Subject(“test”)]
  public event FooDelegate FooEvent;
  FtMemberAction_action;
  Timer_tmr;
  public FtSender( )
  {
    MessagingServices.RegisterObject(this);
    _tmr = new Timer(new TimerCallback(OnTimer), null, 0, 1000);
  }
  void OnTimer(Object state)
  {
    if (_action == FtMemberAction.Activate)
    {
      FooEvent(DateTime.Now);
    }
  }
  public void Notify(String groupName, FtMemberAction action)
  {
      _action = action;
  }
}
```

10.7 Fault Tolerant Group Monitor Attribute

TABLE 10.7.1
Characteristics

| Name | FaultTolerantGroupMonitorAttribute |
|---|---|
| Description | This attribute should be used on classes |
| | implementing the IFtGroupMonitor |
| | interface. This interface allows an object |
| | to monitor a fault tolerant group. |
| Targets | Classes |
| Inheritable | Yes |
| Allow multiple on a target | No |
| Mandatory | No |

TABLE 10.7.2
Mandatory Positional Parameters

| Name | Type | Description |
|---|---|---|
| Name | String | Specifies the name of the FT group to |
| | | monitor. |
| LostInterval | Double | Specifies the interval (in seconds) after |
| | | detecting a lost active member when the |
| | | monitor is notified through the |
| | | IFtGroupMonitor.Notify method. |

TABLE 10.7.3
Named Properties

| Name | Type | Description | Default |
|---|---|---|---|
| ConfigID | String | The id in the XML | null |
| | | configuration | |
| | | corresponding to | |
| | | this attribute. | |

### XML Configuration 10.7

```
<faultTolerantGroupMonitors>
  <faultTolerantGroupMonitor
    id=“ConfigID”
    name=“Name of FT group to monitor”
    lostInterval=“Monitor notification interval (seconds)” />
</faultTolerantGroupMonitors>
```

### Interfaces 10.7

interface IFtGroupMonitor
{
void Notify(String groupName, UInt32 numActiveMembers);
}

In order to monitor changes in a fault tolerant group, a class implementing the IFtGroupMonitor interface should be defined. Moreover, the class should also apply the FaultTolerantGroupMonitor attribute and specify a ReliableTransport attribute to enable a distributed FT group. All FT monitors within a group should specify the same ReliableTransport parameters. A Queue attribute could also be used to designate a non-default queue to hold FT monitor notification events.

### EXAMPLE 10.7

```
// This C# snippet shows how to monitor an FT group.
[ReliableTransport]
[FaultTolerantGroupMonhtor(“ft1”, 10)]
public class FtMonitor : IFtGroupMonitor
{
  public FtMonitor( )
  {
    MessagingServices.RegisterObject(this);
  }
  public void Notify(String groupName, UInt32 memberCount)
  {
    Console.WriteLine(“Group {0}, Count {1}”,
    groupName, memberCount);
  }
}
```

10.8 Distributed Queue Attribute

TABLE 10.8.1
Characteristics

| Name | DistributedQueueAttribute |
|---|---|
| Description | This attribute applies to listeners only and |
| | specifies that method/event callbacks |
| | should act as part of a distributed queue |
| | (DQ) group. This will ensure that exactly |
| | one callback within a DQ group of |
| | callbacks should be fired. |
| | Although DQ groups rely on both certified |
| | messaging and fault tolerant functionality, |
| | neither the CertifiedTransport nor |
| | FaultTolerant attributes need to be |
| | specified. |
| Targets | Classes, Interfaces, Delegate |
| Inheritable | Yes |
| Allow multiple on a target | No |
| Mandatory | No. If unspecified, listener callbacks do not |
| | act as part of a DQ group. |

TABLE 10.8.2
Mandatory Positional Parameters

| Name | Type | Description |
|---|---|---|
| Name | String | Specifies the name of the persistent |
| | | correspondent to use for the CM transport. |
| | | The DQ transport will become a member of |
| | | the DQ group with this name. |

TABLE 10.8.3
Optional Positional Parameters

| Name | Type | Description | Default |
|---|---|---|---|
| WorkerWeight | Int32 | This value is used by the | 1 |
| | | DQ mechanism to | |
| | | determine which queue | |
| | | group member will be | |
| | | assigned a task. | |
| WorkerTasks | Int32 | Specifies the maximum | 1 |
| | | number of simultaneous | |
| | | callbacks that should | |
| | | occur on the listener. | |
| SchedulerWeight | Int16 | Specifies the ability of this | 1 |
| | | listener to also act as a | |
| | | scheduler with the DQ | |
| | | group. | |
| SchedulerHeartbeat | Double | Specifies the heartbeat | 1.0 |
| | | interval (in seconds) to | |
| | | use for the scheduler. | |
| SchedulerActivation | Double | Specifies the interval (in | 3.5 |
| | | seconds) after detecting | |
| | | a lost scheduler when an | |
| | | inactive scheduler with | |
| | | the greatest weight | |
| | | should be activated. | |

TABLE 10.8.4
Named Properties

| Name | Type | Description | Default |
|---|---|---|---|
| CompleteTime | Double | Specifies the time limit (in | 0 |
| | | seconds) given to a listener | |
| | | callback to complete a task. | |
| | | If this limit is exceeded, the | |
| | | scheduler will reassign the | |
| | | task to another worker. | |
| | | A value of zero indicates no | |
| | | time limit. | |
| ConfigID | String | The id in the XML | null |
| | | configuration corresponding | |
| | | to this attribute. | |

### XML Configuration 10.8

```
<distributedQueues>
  <distributedQueue
    id=“ConfigID”
    name=“DQ group name”
    workerWeight=“DQ worker weight”
    workerTasks=“DQ task capacity”
    schedulerWeight=“DQ scheduler weight”
    schedulerHeartbeat=“DQ scheduler heartbeat interval (seconds)”
    schedulerActivation=“DQ scheduler activation interval (seconds)”>
    <completeTime>task completion time limit
    (seconds)</completeTime>
  </distributedQueue>
</distributedQueues>
```

This attribute should be used in conjunction with the ReliableTransport attribute, which specifies what transport to use for DQ communications within the group.

### EXAMPLE 10.8

```
// This C# snippet shows how to define a listener in a DQ group.
[ReliableTransport]
[DistributedQueue(“dql”, CompleteTime=20)]
public class DQMember
{
  public DQMember( )
  {
    MessagingServices.RegisterObject(this);
  }
  [Subject(“test”)]
  public void OnMsg(String x)
  {
    // This method will be called only in the active DQ member
  }
}
```

11.0 Notes

The follow are miscellaneous notes on using the Attribute Library to perform other common RV operations such as handling advisory messages, request/reply interactions and using the RV Cache.

11.1 Advisory Messages

Advisory messages can be handled by defining callback methods with the appropriate signature. Since advisory messages are transport-specific, the callback methods should be defined in the scope of the same transport that presents the advisory. In order to retrieve message fields associated with an advisory message, the callback method signature should match the fields by name and type. In addition, the Subject attribute should specify the subject on which the advisory is sent.

### EXAMPLE 11.1

### Queue Limit Exceeded Advisory

```
// This C# snippet shows how to detect when the queue limit is
exceeded
// No transport is specified because the advisory presents itself
// on the intra-process transport.
public class Advisory
{
  public Advisory( )
  {
    MessagingServices.RegisterObject(this);
  }
  // The name of the method can be anything
  [Subject(“_RV.*.SYSTEM.QUEUE.LIMIT_EXCEEDED.*”)]
  public void OnLimitExceeded( )
  {
    // This method is called when a queue limit is exceeded.
  }
}
```

11.2 Request/Reply Interactions

In order to use publish/subscribe messaging with RV, all method signatures should use a return type of void. For request/reply interactions, however, a non-void return type can be specified on a sender method in order to handle the reply in a natural fashion. Note that the method call will become synchronous, and as a result will block until a reply is received. If reliable messaging is used, the tibrvTransport_SendRequest function is used, while for certified messaging the tibrvcmTransport_SendRequest function is used. As a result, a temporary inbox will be use to handle the response message.

### EXAMPLE 11.2

### Request/Reply Interaction

```
// This C# snippet demonstrates a simple request/reply interaction
[ReliableTransport]
public interface IFoo
{
  [Subject(“sum.request”)].
  int GetSum(int x, int y);
}
// Here's the client that need to get a sum result
class Client
{
  static void Main( )
  {
    IFoo f = (IFoo)MessagingServices.CreateProxy(typeof(IFoo));
    int result = f.GetSum(23, 44); // synchronous call
    Console.WriteLine(result);
  }
}
// Here's the server that handles the request and returns the result
[ReliableTransport]
public class Server
{
  public Server( )
  {
    MessagingServices.RegisterObject(this);
  }
  [Subject(“sum.request”)]
  public int DoSum(int x, int y)
  {
    return x + y;
  }
}
```

11.3 Accessing the RV Cache

Retrieving values from the RV Cache involves making a send request with no message fields and receiving the response. The reply subject should be set before sending a request, and the Inbox=true property should be set to ensure that the response is processed only by the requesting application. The following example demonstrates making a cache query. It is assumed that the RV cache daemon is running and configured properly, using the same transport parameters, and that a cached message with a single String field exists on the subject “cached.subject”.

### EXAMPLE 11.3

### Requesting a Cached Value

```
// This C# snippet shows how to get a message from the RV cache
public delegate void CacheDelegate(String s);
[ReliableTransport]
public interface IFoo
{
  [Subject(“_SNAP.cached.subject”)]
  [ReplySubject(“myInbox”, Inbox=true)]
  void SendCacheRequest( );  // no parameters necessary
  [Subject(“myInbox”, Inbox=true)]
  event CacheDelegate CacheResponse;
}
class CacheRequester
{
  public void SendRequest( )
  {
    IFoo f = (IFoo)MessagingServices.CreateProxy(typeof(IFoo));
    f.CacheResponse += new CacheDelegate(OnResponse);
    f.SendCacheRequest( );
  }
  void OnResponse(String s)
  {
    Console.WriteLine(“Cached value is: {0}”, s);
  }
}
```

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes, which come within the meaning and range of equivalency of the claims, are to be embraced within their scope.

What is claimed is:

1. A method of integrating middleware into .NET programs without having to employ middleware application programming interfaces, the method comprising the step of calling a programmatic construct by using an associated attribute.

2. The method of claim 1, wherein the programmatic construct is not static.

3. The method of claim 2, wherein the programmatic construct is selected from the group consisting of delegates, interfaces, classes, or a combination thereof.

4. The method of claim 3, wherein the programmatic constructs can be used to send and receive messages.

5. The method of claim 4, further comprising the step of performing a message sending operation, wherein a type is specified and the attributes provide a middleware-aware implementation of that type.

6. The method of claim 4, further comprising the step of performing a message receiving operation, wherein a type is specified and the attributes provide a middleware-aware implementation of that type.

7. The method of claim 4, further comprising the step of performing a message sending operation, wherein an object reference is supplied and the attributes target that object for middleware usage.

8. The method of claim 4, further comprising the step of performing a message receiving operation, wherein an object reference is supplied and the attributes target that object for middleware usage.

9. The method of claim 8, wherein a method implementation is called upon for a listener to receive a middleware message.

10. The method of claim 2, wherein the programmatic construct is selected from the group consisting of interfaces, classes, or a combination thereof.

11. The method of claim 10, wherein the programmatic construct is created by the attributes through the GetXXProxy methods.

12. The method of claim 10, wherein the programmatic construct is created by a user and registered for usage through the RegisterXX methods.

13. The method of claim 10, wherein the interfaces have methods.

14. The method of claim 13, wherein the interfaces have events.

15. The method of claim 10, wherein the interfaces have events.

16. The method of claim 10, wherein the classes have methods.

17. The method of claim 16, wherein the classes have events.

18. The method of claim 10, wherein the classes have events.

19. The method of claim 1, wherein the attributes are used for security.

20. The method of claim 1, wherein the attributes are used to indicate performance preferences.

21. The method of claim 1, wherein the attributes are used to define transactional needs.

22. The method of claim 1, wherein the attributes are used to indicate that portions of a program are web accessible.

23. The method of claim 1, wherein the attributes are used to call “native” low level libraries of an operating system.

24. A method of using an attribute library to bridge a network infrastructure and a messaging middleware product, the method comprising the steps:
Providing an attribute library;
Defining the type(s) to be used for sending/receiving messages;
Annotating the type(s) with attributes from the attribute library to specify how the types should be used with the underlying middleware infrastructure; and
Using the annotated types within an application.

25. An article of manufacture comprising a computer-readable medium having stored thereon instructions adapted to be executed by a processor, the instructions which, when executed, define a series of steps to allow the integration of middleware into a .NET connected environment without having to employ middleware application programming interfaces, the method comprising the step of calling a programmatic construct by using an associated attribute.
